(19) United States
(12) Patent Application Publication
(10) Pub. No.: US 2026/0241217 A1
(43) Pub. Date: Aug. 20, 2026

(54) SYSTEMS AND METHODS OF SUPPORT CUPS FOR CONCEALED SPRINKLERS

(71) Applicant: Tyco Fire Products LP, Cranston, RI (US)

(72) Inventors: Nicholas Rosa, Cranston, RI (US); Kenneth Wayne Rogers, Horsham, PA (US); Lyle Miller, Milford, CT (US)

(73) Assignee: Tyco Fire Products LP, Cranston, RI (US)

(21) Appl. No.: 19/162,010

(22) PCT Filed: May 2, 2024
(86) PCT No.: PCT/IB2024/054268

§ 371 Date: Sep. 3, 2025

Related U.S. Application Data
(60) Provisional application No. 63/500,222, filed on May 4, 2023.

(51) Int. Cl. A62C 31/28; A62C 37/09; A62C 37/14

(52) U.S. Cl. CPC A62C 31/28; A62C 37/09; A62C 37/14

(57) ABSTRACT

A concealed sprinkler includes a body, a seal, an activation element, a deflector, and a cup. The body includes a passageway having an inlet and an outlet, and defines a longitudinal axis through the inlet and the outlet. The seal couples with the outlet. The activation element couples with the seal and changes state responsive to a fire condition to allow the seal to be displaced from the outlet. The deflector is coupled with the body and positioned along the longitudinal axis. The cup is coupled with the body and includes a first wall that extends from a first point that contacts the body to a second point outward from the first point, a second wall that extends from the second point, and an engagement member that extends to a fourth point at a distance from the third point.

### CROSS-REFERENCE TO RELATED APPLICATIONS

This application claims the benefit of and priority to U.S. Provisional Application No. 63/500,222, filed May 4, 2023, the disclosure of which is incorporated herein by reference in its entirety.

### BACKGROUND

Sprinkler systems can be used to address fire conditions. For example, the sprinkler system can include one or more sprinklers that receive fluid from a fluid supply and output the fluid to address the fire condition.

### SUMMARY

At least one aspect relates to a concealed sprinkler assembly. The sprinkler assembly can include a sprinkler, a cup, and a cover plate. The sprinkler can include a body that includes a passageway having an inlet and an outlet. The passageway can define a longitudinal axis through the inlet and the outlet. The sprinkler can include a seal that seals the outlet. The sprinkler can include an activation element coupled with the seal. The activation element can change from a first state to a second state responsive to a fire condition to allow the seal to be displaced from the outlet. The sprinkler can include a deflector coupled with the body and positioned along the longitudinal axis. The cup can include a first wall that extends from a first point that contacts the body to a second point outward from the first point. The cup can include a second wall that extends from the second point in a direction transverse the first wall to a third point. The cup can include an engagement member that extends along the second wall to a fourth point at a distance from the third point. The cover plate can be coupled with the cup and can be mounted or otherwise coupled with a ceiling or other structure.

At least one aspect relates to a sprinkler. The sprinkler can include a body, a seal, an activation element, a deflector, and a cup. The body can include a passageway. The passageway can have an inlet and an outlet. The passageway can define a longitudinal axis through the inlet and the outlet. The seal can couple with the outlet. The activation element can couple with the seal. The activation element can change from a first state to a second state responsive to a fire condition to allow the seal to be displaced from the outlet. The deflector can be coupled with the body and positioned along the longitudinal axis. The cup can coupled with the body. The cup can include a first wall that extends from a first point that contacts the body to a second point outward from the first point. The cup can include a second wall that extends from the second point in a direction transverse the first wall to a third point. The cup can include an engagement member that extends along the second wall to a fourth point at a distance from the third point.

At least one aspect relates to a cup. The cup can be a support cup of a concealed sprinkler assembly. The cup can include a first wall that extends from a first point to a second point. The first point can couple with a body of a sprinkler. The second point can be outward from the first point. The cup can include a second wall that extends from the second point in a direction transverse the first wall to a third point. The cup can include an engagement member that extends along the second wall to a fourth point at a distance from the third point. The engagement member comprises can include threading. The second wall can include a flat portion between the fourth point and the third point. The distance can be greater than or equal to 0.01 inches and less than or equal to 0.4 inches. The distance can be 0.125 inches.

At least one aspect relates to a method of installing a concealed sprinkler assembly. The method can include coupling a sprinkler with a pipe. The method can include coupling a support cup with the sprinkler. The method can include coupling a cover plate with the support cup such that an end of an engagement member of the support cup proximate a building structure in which the sprinkler disposed is spaced from the building structure.

At least one aspect relates to a method of forming a cup, such as a support cup of a concealed sprinkler assembly. The method can include providing a first wall. The first wall can extend from a first point to a second point. The method can include providing a second wall of the cup. The second wall can extend from the second point, in a direction transverse to the first wall, to a third point. The method can include providing an engagement member, which can include threading, to extend along the second wall to a fourth point. The fourth point can be at a distance from the third point. The method can include shaping the second wall so that the distance corresponds to a target position of a deflector of a sprinkler to be coupled with the support cup.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing. In the drawings:

FIG. 1 is a schematic diagram of an example of a sprinkler system.

FIG. 2 is a perspective view of an example of a concealed sprinkler assembly.

FIG. 3 is a cross-section view of an example of a concealed sprinkler assembly.

FIG. 4 is a cross-section view of an example of a cup of a concealed sprinkler assembly.

FIG. 5 is a flow diagram of a method of installing a concealed sprinkler assembly.

FIG. 6 is a flow diagram of a method of manufacturing a support cup of a concealed sprinkler assembly.

### DETAILED DESCRIPTION

Following below are more detailed descriptions of various concepts related to, and implementations of systems and methods of support cups for concealed sprinklers, such as support cups that can be implemented in concealed sprinkler assemblies. The various concepts introduced above and discussed in greater detail below can be implemented in any of numerous ways, including in residential ceiling implementations.

Concealed sprinklers can include and/or be coupled with a support cup and a cover plate. These components can be positioned around components of the sprinkler, such as a deflector and activation element, and between the sprinkler and a space that the sprinkler is to protect, such as a room in a building, including but not limited to residential buildings. The support cup can facilitate connecting the cover plate with the sprinkler. The cover plate can conceal components of the sprinkler relative to the space, providing for aesthetic benefits. The sprinkler can be installed in a cavity in a structure, such as a ceiling. For example, the sprinkler can be installed in a cavity defined in a concrete ceiling. The sprinkler can be installed in an open ceiling. The sprinkler can be connected with a wet pipe system.

The cup can be coupled with the sprinkler and with the cover plate to provide an assembly of the sprinkler, cup, and cover plate. The cup can be positioned around at least some components of the sprinkler (e.g., deflector; frame arms; activation element). The cover plate can engage with the cup and a ceiling or other structure, such as to at least partially provide a visual barrier between components of the sprinkler and a room in which the ceiling or other structure is provided.

In installations of concealed sprinklers, it may be useful to have adjustability of the positioning of one or more of the sprinkler, cup, and cover plate relative to one another and/or relative to a structure in which the concealed sprinkler is arranged, such as a ceiling. For example, to meet performance targets or criteria, it may be useful for the deflector or other components of the sprinkler to be arranged at a particular position or range of positions relative to the ceiling or other structures or spaces defined in structures relative to which the sprinkler is installed, so that responsive to being deployed, the deflector can be moved to an appropriate location to achieve a target spray pattern for output of fluid from the sprinkler.

For example, spray patterns of fluid outputted by the sprinklers can depend on the relative positioning between the deflector, ceiling, and/or floor. At the same time, the positioning of the sprinkler can depend on the structure of the components of the sprinkler relative to the structure (e.g., relative to the ceiling). For example, a cover plate may be threaded into a support cup until a stopping point corresponding to an end of threading of the support cup.

Systems and methods in accordance with the present disclosure can implement support cups for concealed sprinklers that can facilitate more useful adjustability in positioning of the cup and cover plate—and thus the deflector or other components of the sprinkler—to achieve target performance. The cup can allow for cover plates having varying structures to be coupled with the sprinkler and/or sprinklers having varying structures, or being structured for varying use cases, to be implemented using the same or similar cover plates.

For example, the cup can include threading for engaging with the cover plate; the threading can terminate away from a (lower) edge of the cup (e.g., as opposed to extending all the way to the edge). By terminating the threading away from the lower edge of the cup, the size of the cup can account for the size of the cover plate, such that an adjustability characteristic of the sprinkler can be matched with a size of the cup and/or the cover plate.

As an example, some sprinkler assemblies, such as sprinklers assemblies for concealed pendent sprinklers having a K-factor of 3.0 (among other K factors, such as for residential sprinkler applications), may satisfy a performance criteria (e.g., a certification criteria that may depend on vertical positioning of the sprinkler or components thereof) corresponding to a first vertical adjustment characteristic in use with a cover plate (e.g., ⅝ inches adjustment) while being structured for a second vertical adjustment characteristic (e.g., ¾ inches adjustment); by terminating the threading at a distance from the edge (e.g., ⅛ inch from the edge), the sprinkler assembly can satisfy the performance criteria while being able to be used with the cover plate.

For example, a sprinkler assembly, such as a concealed sprinkler assembly, can include a sprinkler, a cup, and a cover plate. The sprinkler can include a body that includes a passageway having an inlet and an outlet. The passageway can define a longitudinal axis through the inlet and the outlet. The sprinkler can include a seal that seals the outlet. The sprinkler can include an activation element coupled with the seal. The activation element can change from a first state to a second state responsive to a fire condition to allow the seal to be displaced from the outlet. The sprinkler can include a deflector coupled with the body and positioned along the longitudinal axis. The cup can include a first wall that extends from a first point that contacts the body to a second point outward from the first point. The cup can include a second wall that extends from the second point in a direction transverse the first wall to a third point. The cup can include an engagement member that extends along the second wall to a fourth point at a distance from the third point. The cover plate can be coupled with the cup and can be mounted or otherwise coupled with a ceiling or other structure. By extending the engagement member up until the fourth point (e.g. while providing a flat portion between the end of the engagement member at the fourth point and the third point), the cup can more effectively control vertical adjustability for how the sprinkler can be installed in a ceiling or other structure.

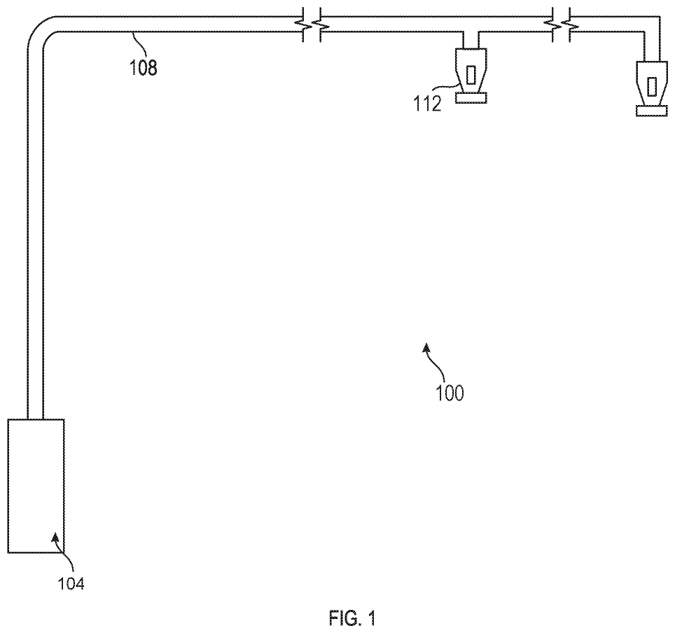

FIG. 1 depicts an example of a sprinkler system 100. The sprinkler system 100 can include a fluid supply 104. The fluid supply 104 can store fluids to be used to address a fire condition, which can include at least one of water and one or more fire suppression agents.

The sprinkler system 100 can include one or more pipes 108. The pipes 108 can be connected with the fluid supply 104 and extend from the fluid supply 104. The pipes 108 can extend through a structure, such as a building. Fluid from the fluid supply 104 can be present in the pipes 108 and flow through the pipes 108. The pipes 108 can include any of a variety of conduits that can be used to flow fluid (e.g., water or other fire suppression agents), including but not limited to piping, tubing, metal pipes, rigid pipes, or polymeric (e.g., chlorinated polyvinyl chloride (CPVC)) pipes.

The sprinkler system 100 can include at least one sprinkler 112. The sprinkler 112 can receive fluid from the fluid supply 104 through the one or more pipes 108 and output the fluid to address a fire condition. The sprinkler 112 can be a concealed sprinkler. The sprinkler 112 can have various K-factors, such as K-factors used for residential sprinkler applications. For example, the sprinkler 112 can have a K-factor including but not limited to a K-factor of 3.0. The sprinkler system 100 can include a plurality of sprinklers 112, which can be arranged at various locations relative to the structure.

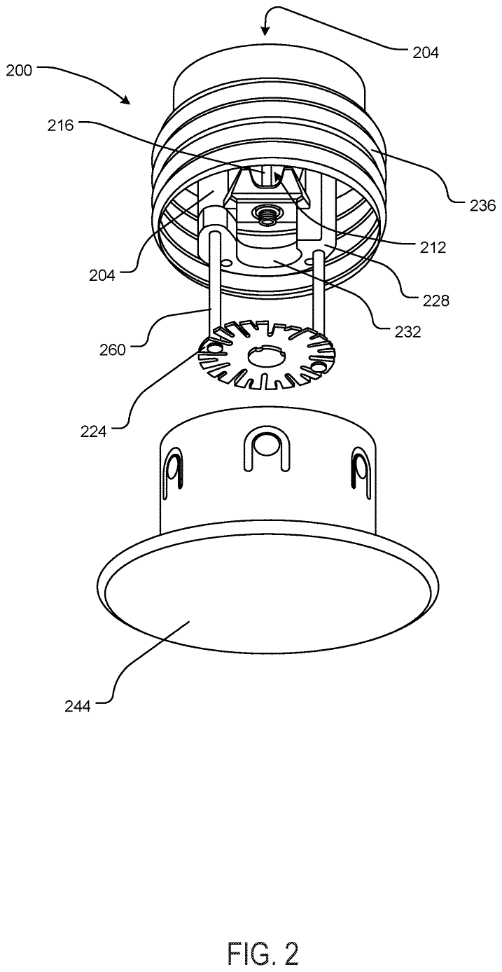

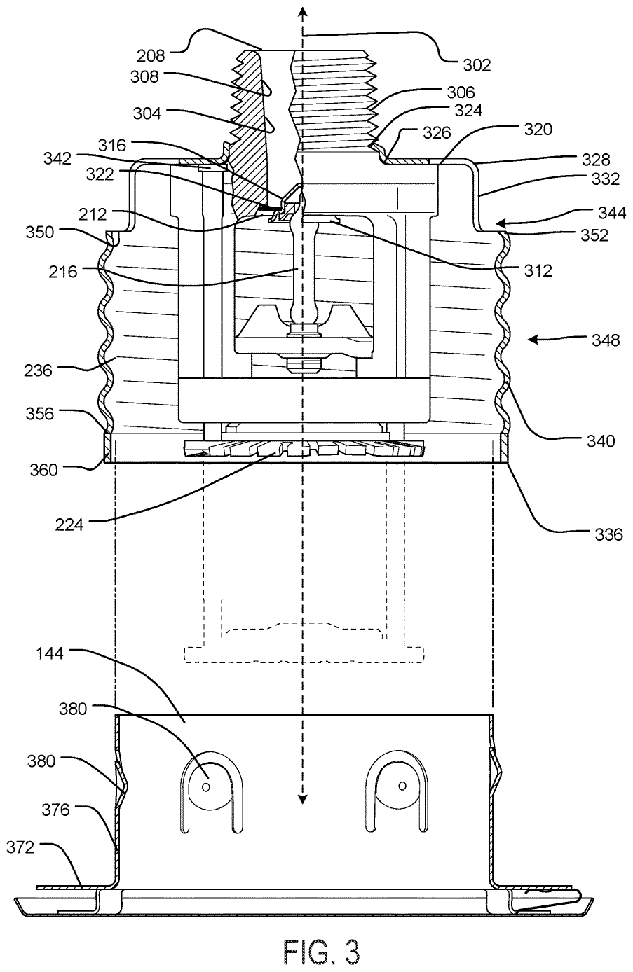

The one or more pipes 108 can extend through at least a portion of a building structure. A cavity can be formed in the building structure to receive the sprinkler 112 (as well as sprinkler assembly 200 described with reference to FIGS. 2 and 3). The sprinkler 112 can be at least partially positioned in the cavity to be coupled with the one or more pipes 108. The cavity can be at least partially open to a space below the ceiling, such as a space that the sprinkler 112 is used to protect in the event of a fire condition. The sprinkler 112 can be arranged in or coupled with a sprinkler box provided in the cavity. The sprinkler box can be a box used to support or install the sprinkler 112 in the ceiling, such as in a concrete ceiling installation.

FIGS. 2 and 3 depict an example of a sprinkler assembly 200 that includes the sprinkler 112. The sprinkler 112 can include a body 204 that defines a fluid passageway 304 extending from an inlet 208 (which can be coupled with the one or more pipes 108) to an outlet 212. The passageway 304 can extend along a longitudinal axis 302 and can have an inner wall 308 having various form factors; for example, as depicted in FIG. 3, the inner wall 308 can taper in a direction along the longitudinal axis 302 from the inlet 208 to the outlet 212. The body 204 can include an engagement member 306, such as threads, to couple the sprinkler 112 with the one or more pipes 108.

The sprinkler 112 can include a seal 312 that seals the outlet 212. The seal 312 can include a button 316 and a spring 322w (e.g., Belleville spring) coupled with the button 316 between the button 316 and the inner wall 308 of the passageway 304.

The sprinkler 112 can include an activation element 216, such as a thermal trigger, coupled with the seal 312 to maintain the seal 312 in a first state in which the seal 312 seals the outlet 212. The activation element 216 can include one or more components that change state from the first state to a second state by being activated responsive to a fire condition (e.g., responsive to temperature or a rate of rise of temperature meeting or exceeding a threshold value). In the second state, at least a portion of the activation element 216 can be separated from a remainder of the activation element 216.

As depicted in FIGS. 2 and 3, the activation element 216 can include a bulb that includes a fluid that expands to break the bulb (e.g., responsive to the fire condition). The activation element 216 can include a fusible link (e.g., link components coupled with solder) that separates responsive to the fire condition to break. For example, by changing state, the activation element 216 can discontinue applying a force against the seal 312, allowing the seal 312 to move away from the outlet 212 to allow fluid to flow through the outlet 212.

The sprinkler 112 can include a deflector 224 downstream of the outlet 212. The deflector 224 can receive the fluid that flows out of the outlet 212 and deflect the fluid according to a target spray pattern (e.g., a spray pattern corresponding to the geometry of the deflector 224). The target spray pattern can represent a proportion of outputted fluid that reaches one or more geometric regions relative to the sprinkler 112, such as at a given distance in a plane below or otherwise positioned relative to the sprinkler 112. The distance at which the target spray pattern is evaluated and/or achieved can correspond to the performance of the sprinkler 112 and/or be useful for characterizing the performance of the sprinkler 112.

The sprinkler 112 can include at least one frame arm 228 extending from the body 204. The frame arms 228 can extend along the longitudinal axis 302 and outward of the longitudinal axis 302 and the activation element 216, to a base 232 extending across between the frame arms 228.

The sprinkler 112 can include at least one guide pin 260 coupled with a respective frame arm 228 of the at least one frame arm 228. The guide pins 260 can be coupled with the deflector 224, and can facilitate deploying the deflector 224 responsive to a fire condition. For example, responsive to various triggers corresponding to the fire condition (e.g., cover plate 244 being released; deflector 224 being released; fluid contacting the deflector 224) the guide pins 260 can be driven away from the inlet 208 to move the deflector 224 into a deployed position (dashed lines in FIG. 3) further from the inlet 208. The guide pins 260 can include end stops 342 to prevent further movement away from the inlet 208 along the longitudinal axis 302 beyond an opening in the base 232 in which the guide pins 260 are received.

As depicted in FIGS. 2-4, the sprinkler assembly 200 can include a cup 236. The cup 236 can be a support cup, such as a structure to support the sprinkler 112 for installation as in a ceiling or other concealed location. The cup 236 can be made of various materials, including metal, composite, and/or polymeric materials. For example, the cup 236 can be made of a steel material.

The cup 236 can be coupled with the body 204 (e.g., an end of the body proximate the engagement member 206). The cup 236 can extend outward of the frame arms 228, such as to at least partially form a housing around the sprinkler 112 and components thereof.

The cup 236 can include a first wall 320. The first wall 320 can extend from a first point 324 to a second point 328. The first wall 320 can extend in a direction outward from the longitudinal axis 302 from the first point 324 to the second point 328. The first point 324 can contact the body 204, such that the first wall 320 can couple with the body 204 at the first point 324.

For example, as depicted in FIG. 3, the first point 324 can contact a portion of the body 204 between the engagement member 206 and the outlet 212. The first wall 320 can include one or more bends 326 between the first point 324 and the second point 328 to facilitate forming engagement between the cup 236 and the body 204 of the sprinkler 112.

The cup 236 can include a second wall 332. The second wall 332 can be contiguous with the first wall 320, and can extend from the second point 328 to a third point 336. The second wall 332 can extend in a direction transverse to a direction along which the first wall 320 extends, such as to be perpendicular or substantially perpendicular (e.g., within twenty degrees; within ten degrees; within five degrees of perpendicular) to the direction along which the first wall 320 extends. For example the second wall 332 can extend parallel with or substantially parallel with (e.g., within twenty degrees; within ten degrees; within five degrees of parallel) the longitudinal axis 302. The second wall 332 can be longer than the first wall 320. The third point 336 can correspond to a terminal end of the second wall 332 furthest from the first point 324.

The second wall 332 can include at least one engagement member 340. The engagement member 340 can include threads, such as rolled threads. The engagement member 340 can form and/or extend along at least a portion of the second wall 332. As depicted in FIG. 3, the engagement member 340 can be formed along a second portion 348 of the second wall 332 that is outward from a first portion 344.

The engagement member 340 can extend along the second portion 348 from an edge 352 (e.g., a fifth point at the edge 352) between the first portion 340 and the second portion 344. For example, the second wall 332 can include a portion 350 (e.g., a flat portion) that extends outward from the second point 328 to the edge 352.

The engagement member 340 can extend (e.g., from the edge 352) to a fourth point 356, such as to form a third portion 360 between the fourth point 356 and the third point 336. The third portion 360 can have a different shape than the engagement member 340, such as to be flat or uncurved (e.g., the third portion 360 can include flat outer and/or inner surfaces).

For example, the fourth point 356 can be at a distance 404 from the third point 336. The distance 404 can represent the distance along which the third portion 360 is formed, such as where the third portion 360 is flat or has a different shape or curvature than the engagement member 340 to separate the engagement member 340 from the terminal end of the cup 236 corresponding to the third point 336. The distance 404 can allow for greater adjustability of positioning of the sprinkler assembly 200. The distance 404 can be greater than or equal to 0.01 inches and less than or equal to 0.4 inches. The distance 404 can be greater than or equal to 0.02 inches and less than or equal to 0.3 inches. A ratio of the distance 404 to a length 408 of the second wall 332 can be greater than or equal to 1:20 and less than or equal to 1:4. The ratio can be greater than or equal to 1:10 and less than or equal to 1:5. The ratio can be greater than or equal to 1:8 and less than or equal to 1:6. A ratio of the distance 404 to a width 412 of the cup 236 can be greater than or equal to 1:100 and less than or equal to 1:5; the ratio can be greater than or equal to 1:50 and less than or equal to 1:4; the ratio can be greater than or equal to 1:20 and less than or equal to 1:8. As such the engagement member 340 can terminate away from the end of the second wall 332 corresponding to the third point 336, such as to terminate at the distance 404 from the third point 336. By forming the cup 236 to include the third portion 360, such as to form the third portion 360 as a flat portion distinct from the engagement member 340, the cup 236 can enable more effective adjustability of positioning of the sprinkler assembly 200 relative to a building or other structure in which the sprinkler 112 is to be installed.

For example, as described further below, the third portion 360 can allow the sprinkler 112 to be used with the cover plate 244 while still meeting performance criteria relating to vertical adjustability for positioning of the sprinkler 112 relative to the space that the sprinkler 112 is to provide fire protection for (including components of the sprinkler 112, such as the activation element 216 and deflector 224, for which performance may depend on relative distance between the components and the space and/or a fire in the space). The third portion 360 can, for example, prevent the cup 236 from being threaded all the way to the third point 336 responsive to receiving cover plate 244.

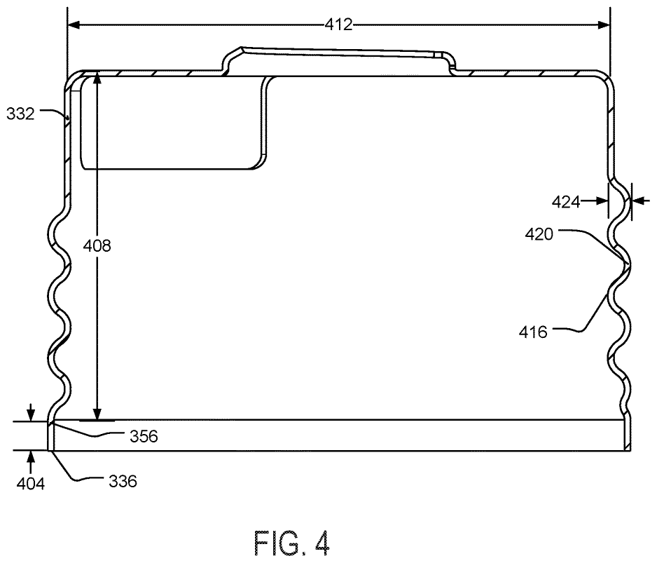

As depicted in FIGS. 3 and 4, the engagement member 340 can include threading that varies in radial distance from the longitudinal axis 302. For example, the engagement member 340 can extend inward (e.g., from a central axis of the second wall 332 and/or an axis through the third portion 368, towards the longitudinal axis 302) to a root 416, and outward from the longitudinal axis 302 to a crest 420, to define a distance 424 between the root and the crest. The engagement member 340 can be sized (e.g., the distance 424 can be designed) to effectively couple with cover plate 244 while providing sufficient room for the sprinkler 112 and components thereof. For example, a ratio of the distance 424 to the distance 404 can be greater than or equal to 1:4 and less than or equal to 4:1. The ratio can be greater than or equal to 1:2 and less than or equal to 2:1. The ratio can be greater than or equal to 1:1.5 and less than or equal to 1.5:1.

As depicted in FIGS. 2 and 3, the sprinkler assembly 200 can include or be coupled with a cover plate 244. The cover plate 244 can be used to at least partially conceal the sprinkler 112, such as to form a visual barrier between the sprinkler 112 and the space to be protected by the sprinkler 112. For example, at least one surface 372 of the cover plate 244 can be positioned adjacent to (e.g., flush with) a ceiling or other wall or structure in which the sprinkler assembly 200 is to be installed.

The cover plate 244 can be removably coupled with one or more components of the sprinkler assembly 200, such as to be removably coupled with the cup 236. The cover plate 244 can at least partially extend beyond a space defined by a perimeter of the deflector 224 or other components of the sprinkler 112. The cover plate 244 can be made of various materials, such as stainless steel, brass, plastic, composite, or copper.

As depicted in FIG. 3, the cover plate 244 can include a wall 376 extending from the surface 372 (e.g., transverse to the surface 372), and can include at least one engagement member 380 on the wall 376. The engagement members 380 can include one or more fasteners such as dimples (e.g., as depicted in FIG. 3), tabs, or threading, which can engage with the engagement member 340 of the cup 236 at various positions along the engagement member 340 relative to the longitudinal axis 302. The surface 372 can be formed by a first portion of the cover plate 244 that is removably coupled with a second portion, such as by walls that are coupled by solder; the solder can have a thermal rating such that the solder releases the portions from one another responsive to a fire condition to allow the cover plate 244 or a portion thereof to drop away from the cup 236.

In some installations, the cover plate 244 is coupled with the cup 236 by engaging the wall 376 with the cup 236 until the third point 336 contacts the surface 372 and/or an intersection of the surface 372 and the wall 376. By terminating the engagement member 340 away from the third point 336, the cup 236 can provide space for modifying the vertical adjustability of the sprinkler 112 relative to the ceiling or other structure in which the sprinkler assembly 200 is received, such as to facilitate adjusting the sprinkler 112, while coupled with the cover plate 244, to a position corresponding to an adjustment criteria for the sprinkler 112.

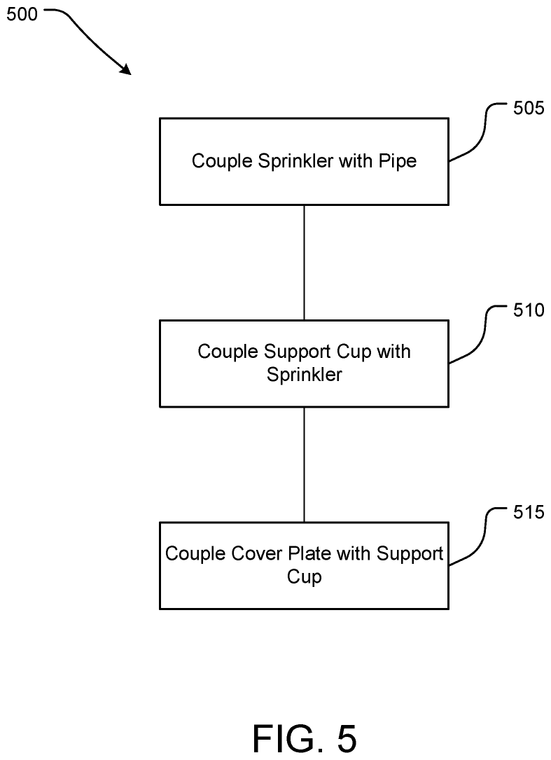

FIG. 5 depicts an example of a method 500 of installing a concealed sprinkler assembly. The method 500 can be performed by various users, including, for example, for performing various installation and/or retrofitting operations. The method 500 can be performed to provide a sprinkler in a building.

At 505, a sprinkler can be coupled with a pipe. The sprinkler can be engaged with the pipe or a fitting coupled with the pipe, such as by threading an engagement member of the sprinkler into a corresponding engagement member of the pipe or fitting. The sprinkler can have a support cup coupled with a body of the sprinkler, such as to position the support cup around components of the sprinkler such as a deflector and an activation element. The pipe can extend in a portion of a building or other structure, such as to extend along or proximate a ceiling or an opening or cavity of the ceiling. The sprinkler can coupled with the pipe to be positioned at a target position, such as a target position to meet one or more criteria regarding performance of the sprinkler for providing fire protection for the building or a space in the building adjacent to the sprinkler.

At 510, a support cup can be coupled with the sprinkler. For example, the support cup can include a wall forming an opening to receive the sprinkler such that the wall can contact and/or engage the sprinkler.

At 515, a cover plate can be coupled with the support cup. For example, the support cup can include an engagement member, such as threads, extending along a wall of the support cup. The threads can extend up to a non-threaded (e.g., flat) portion of the wall at an edge of the wall. The cover plate can include a corresponding engagement member to couple with the engagement member of the support cup; for example, the corresponding engagement member can be on a radial wall of the cover plate extending from a base of the cover plate. The cover plate can be coupled with the support cup by threading the corresponding engagement member into the support cup up to the non-threaded portion, such as to maintain a relative position of the support cup, cover plate, and sprinkler to achieve a target spray pattern. For example, rotation of the corresponding engagement member into the support cup can be stopped at a selected point of adjustment of the cover plate relative to the support cup.

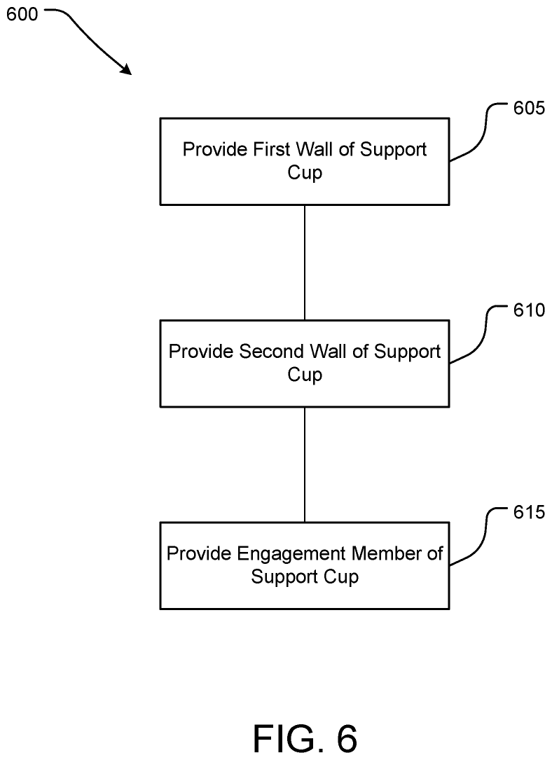

FIG. 6 depicts an example of a method 600 of forming a cup, such as a support cup of a concealed sprinkler assembly. The method can be implemented by performing various types of manufacturing operations.

At 605, a first wall of the cup can be provided. The first wall can extend from a first point to a second point. At 610, a second wall of the cup can be provided. The second wall can extend from the second point, in a direction transverse to the first wall, to a third point. At 615, an engagement member can be provided to extend along the second wall to a fourth point. The fourth point can be at a distance from the third point (e.g., closer to the second point than the third point). The engagement member can include threading. The second wall can include a flat portion between the fourth point and the third point. The engagement member can extend along the second wall from a fifth point to the fourth point, and the second wall can include a flat portion between the second point and the fifth point.

The distance can be greater than or equal to 0.01 inches and less than or equal to 0.4 inches. A ratio of the distance to a length of the second wall can be greater than or equal to 1:20 and less than or equal to 1:4. A ratio of the distance to a width of the cup can be greater than or equal to 1:100 and less than or equal to 1:5. The distance can be a first distance, and the engagement member can extend inward towards the longitudinal axis to a root and outwards away from the longitudinal axis to a crest to define a second distance between the root and the crest. A ratio of the first distance to the second distance can be greater than or equal to 1:4 and less than or equal to 4:1.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. Further relative parallel, perpendicular, vertical or other positioning or orientation descriptions include variations within +/−10% or +/−10 degrees of pure vertical, parallel or perpendicular positioning. References to “approximately,” “about” “substantially” or other terms of degree include variations of +/−10% from the given measurement, unit, or range unless explicitly indicated otherwise.

Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

What is claimed is:

1. A concealed sprinkler, comprising:
a body that includes a passageway, the passageway has an inlet and an outlet, the passageway defines a longitudinal axis through the inlet and the outlet;
a seal that seals the outlet;
an activation element coupled with the seal, the activation element to change from a first state to a second state responsive to a fire condition to allow the seal to be displaced from the outlet;
a deflector coupled with the body and positioned along the longitudinal axis; and
a cup coupled with the body, the cup comprising:
a first wall that extends from a first point that contacts the body to a second point outward from the first point;
a second wall that extends from the second point in a direction transverse the first wall to a third point; and
an engagement member that extends along the second wall to a fourth point at a distance from the third point.

2. The concealed sprinkler of claim 1, comprising:
the engagement member comprises threading, and the second wall comprises a flat portion that is contiguous with the engagement member and disposed between the fourth point and the third point.

3. The concealed sprinkler of claim 1, comprising:
the distance is greater than or equal to 0.01 inches and less than or equal to 0.4 inches.

4. The concealed sprinkler of claim 1, comprising:
a ratio of the distance to a length of the second wall is greater than or equal to 1:20 and less than or equal to 1:4.

5. The concealed sprinkler of claim 1, comprising:
the engagement member extends along the second wall from a fifth point to the fourth point, the second wall comprises a flat portion between the second point and the fifth point.

6. The concealed sprinkler of claim 1, comprising:
a ratio of the distance to a width of the cup is greater than or equal to 1:100 and less than or equal to 1:5.

7. The concealed sprinkler of claim 1, comprising:
the engagement member extends along the second wall from a fifth point to the fourth point, the second wall comprises a flat portion between the second point and the fifth point, the flat portion is shorter than the distance.

8. The concealed sprinkler of claim 1, comprising:
the distance is a first distance, the engagement member extends inward towards the longitudinal axis to a root and outwards from the longitudinal axis to a crest to define a second distance between the root and the crest, a ratio of the first distance to the second distance is greater than or equal to 1:4 and less than or equal to 4:1.

9. A support cup of a concealed sprinkler, comprising:
a first wall that extends from a first point to a second point, the first point to couple with a body of a sprinkler, the second point outward from the first point;
a second wall that extends from the second point in a direction transverse the first wall to a third point; and
an engagement member that extends along the second wall to a fourth point at a distance from the third point, the engagement member comprises threading, the second wall comprises a flat portion between the fourth point and the third point, the distance is greater than or equal to 0.01 inches and less than or equal to 0.4 inches.

10. The support cup of claim 9, comprising:
a ratio of the distance to a length of the second wall is greater than or equal to 1:20 and less than or equal to 1:4.

11. The support cup of claim 9, comprising:
the flat portion is a first flat portion, the engagement member extends along the second wall from a fifth point to the fourth point, the second wall comprises a second flat portion between the second point and the fifth point.

12. The support cup of claim 9, comprising:
a ratio of the distance to a width of the cup is greater than or equal to 1:100 and less than or equal to 1:5.

13. The support cup of claim 9, comprising:
the flat portion is a first flat portion, the engagement member extends along the second wall from a fifth point to the fourth point, the second wall comprises a second flat portion between the second point and the fifth point, the flat portion is longer than the distance.

14. The support cup of claim 9, comprising:
the distance is a first distance, the engagement member extends inward towards a longitudinal axis of the second wall to a root and outwards away from the longitudinal axis to a crest to define a second distance between the root and the crest, a ratio of the first distance to the second distance is greater than or equal to 1:4 and less than or equal to 4:1.

15. A sprinkler assembly, comprising:
a body that includes a passageway, the passageway has an inlet and an outlet, the passageway defines a longitudinal axis through the inlet and the outlet;
a seal to couple with the outlet;
an activation element to couple with the seal, the activation element to change from a first state to a second state responsive to a fire condition to allow the seal to be displaced from the outlet;
a deflector coupled with the body and positioned along the longitudinal axis; and
a cup to couple with the body, the cup comprising:
a first wall that extends from a first point that contacts the body to a second point outward from the first point;
a second wall that extends from the second point in a direction transverse the first wall to a third point; and
an engagement member that extends along the second wall to a fourth point at a distance from the third point.

16. The sprinkler assembly of claim 15, comprising:
the engagement member comprises threading, and the second wall comprises a flat portion between the fourth point and the third point.

17. The sprinkler assembly of claim 15, comprising:
the distance is greater than or equal to 0.01 inches and less than or equal to 0.4 inches; and
a ratio of the distance to a length of the second wall is greater than or equal to 1:20 and less than or equal to 1:4.

18. The sprinkler assembly of claim 15, comprising:
the engagement member extends along the second wall from a fifth point to the fourth point, the second wall comprises a flat portion between the second point and the fifth point.

19. The sprinkler assembly of claim 15, comprising:
a ratio of the distance to a width of the cup is greater than or equal to 1:100 and less than or equal to 1:5; and
the engagement member extends along the second wall from a fifth point to the fourth point, the second wall comprises a flat portion between the second point and the fifth point, the flat portion is longer than the distance.

20. The sprinkler assembly of claim 15, comprising:
the distance is a first distance, the engagement member extends inward towards the longitudinal axis to a root and outwards away from the longitudinal axis to a crest to define a second distance between the root and the crest, a ratio of the first distance to the second distance is greater than or equal to 1:4 and less than or equal to 4:1.
